(19) United States
(12) Patent Application Publication
(10) Pub. No.: US 2011/0310638 A1
(43) Pub. Date: Dec. 22, 2011

(54) POWER FACTOR CORRECTOR AND DRIVING METHOD THEREOF

(76) Inventors: Myungbok KIM, Gyeryong (KR); Dongkook SON, Bucheon (KR)

(21) Appl. No.: 13/161,789

(22) Filed: Jun. 16, 2011

(30) Foreign Application Priority Data
Jun. 18, 2010 (KR) 10-2010-0058184

(51) Int. Cl. H02M 3/335

(52) U.S. Cl. 363/21.02

(57) ABSTRACT

The present invention relates to a power factor corrector and a driving method thereof.

The present invention includes a transformer including a first coil of a primary side transmitted with an input voltage and a second coil of a secondary side generating an output voltage. A power switch is connected to the first coil, and a capacitor removes a ripple of the output voltage. A diode is connected between the capacitor and the second coil. A resonance is generated between the capacitor and a leakage inductance of the transformer during a turn-on period of the power switch, and a resonance is generated between the capacitor and the magnetizing inductance of the transformer during the turn-off period of the power switch.

### CROSS-REFERENCE TO RELATED APPLICATION

This application claims priority to and the benefit of Korean Patent Application No. 10-2010-0058184 filed in the Korean Intellectual Property Office on Jun. 18, 2010, the entire contents of which are incorporated herein by reference.

### BACKGROUND OF THE INVENTION

(a) Field of the Invention

The present invention relates a power supply. More particularly, the present invention relates to power factor corrector. In detail, the present invention relates to a power factor corrector capable of rectifying an AC input into a DC output.

(b) Description of the Related Art

A conventional power supply converts an AC input into a DC output through two stages. The power supply converts the AC power supplied to the power supply into a high voltage of the DC type through power factor corrector in the first stage of two stages. The power supply loads the high DC voltage and converts it into the appropriate DC voltage in the second stage. However, in such applications under 100 W power rating, it is advantageous to supply the power through a single stage rather than through two stages in aspects of cost and efficiency.

In general, there are a flyback type and a forward type as power factor correctors supplying power through a single stage.

A main transformer used for the flyback type of converter has relatively low usage such that it has a drawback in that the size of the main transformer is increased. Also, the current formed when a main switch controlling the converter is turned on in the flyback type is linearly increased such that switching loss is very large when the main switch is turned off. Also, energy stored in a leakage inductance may be applied to the voltage stress of the main switch, and a snubber circuit should be employed to clamp this. In general, the power loss dissipated in the snubber is related to the energy stored in the leakage inductance of the main transformer. That is, as the energy is increased, the voltage applied to the snubber circuit is also increased, and the dissipative power is consequently increased by the resistor of the snubber circuit.

Also, a high voltage is formed across the drain to source terminal of a MOSFET as a sum of rectified input voltage and reflected voltage from the secondary stage of the transformer such that a high voltage rating device is required. Likewise, the power loss in the snubber circuit used to reduce the high voltage stress of the secondary diode is related to the voltage across the secondary diode. Accordingly, the flyback type has low efficiency due to the main transformer of the large size and the easy generation of power loss.

The forward type is operated according to a discontinuous conduction mode such that the power factor corrector is insufficient. Also, the forward type has a drawback in that it converts the AC input having the wide range under the characteristic of the circuit into a uniform DC output voltage. Accordingly, the forward type is not adequate as a power factor corrector for single stage solution.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a power factor corrector and a driving method thereof that are capable of controlling high efficiency and a wide voltage range of an AC power input to a DC output.

A power factor corrector according to the present invention includes: a transformer including a first coil of a primary side transmitted with an input voltage and a second coil of a secondary side generating an output voltage; a power switch connected to the first coil; a capacitor to remove a ripple of the output voltage; and a diode connected between the capacitor and the second coil. A resonance is generated between the capacitor and a leakage inductance of the transformer during a turn-on period of the power switch, and a resonance is generated between the capacitor and the magnetizing inductance of the transformer during a turn-off period of the power switch.

The resonance may start between the capacitor and the leakage inductance of the transformer in synchronization with the turn-on time. When the transformer becomes demagnetized within the turn-off period of the power switch, the resonance may start between the capacitor and the magnetizing inductance of the transformer.

The power factor corrector may further include a rectification diode connected between the capacitor and the output terminal of the power factor corrector. The capacitor may include one terminal connected to one terminal of the second coil and the other terminal connected to the anode of the rectification diode, the anode of the diode may be connected to the other terminal of the capacitor, and the cathode of the diode may be connected to the other terminal of the second coil.

The power factor corrector may further include a feedback unit generating a feedback voltage corresponding to the output voltage, and a switch controller turning off the power switch when a ramp signal increasing with a predetermined slope during a turn-on period of the power switch arrives at the feedback voltage, and turning on the power switch after a predetermined delay period from a time that a drain-source voltage of the power switch starts to decrease. The power factor corrector may further include an auxiliary coil generating an auxiliary voltage that is the voltage of the first coil converted with a predetermined turn ratio, and the controller turns on the power switch after the delay period from the time that the auxiliary voltage starts to decrease.

A method for driving a power factor corrector including a transformer including a first coil of a primary side transmitted with an input voltage and a second coil of a secondary side generating an output voltage, a power switch controlling the operation of the transformer, and a capacitor connected to the second coil according to the present invention includes: generating a resonance between the capacitor and a leakage inductance of the transformer during a turn-on period of the power switch; and generating a resonance between the capacitor and the magnetizing inductance of the transformer during a turn-off period of the power switch.

The generating of the resonance between the capacitor and the leakage inductance of the transformer during the turn-on period of the power switch may start from a time that the power switch is turned on. The generating of the resonance between the capacitor and the magnetizing inductance of the transformer during the turn off period of the power switch may start while the transformer becomes demagnetized.

The method may further include: generating a feedback voltage corresponding to the output voltage; turning off the power switch when a lamp signal increasing with a predetermined slope during the turn-on period of the power switch arrives at the feedback voltage; and turning on the power switch after a predetermined delay period from a time that the drain-source voltage of the power switch starts to decrease.

The present invention provides a power factor corrector and a driving method thereof that are capable of controlling a wide voltage range of an AC input to a DC output with high efficiency.

### BRIEF DESCRIPTION OF THE DRAWINGS

FIG. 1 is a view showing a power factor corrector according to an exemplary embodiment of the present invention.

FIG. 2 is a waveform diagram showing a gate voltage, a primary current IP, a drain-source voltage VDS, a current ICR, and a capacitor voltage VCR during a switching cycle of a power switch.

FIG. 3A is an equivalent circuit of the power factor corrector during a period T0-T1 in FIG. 2.

FIG. 3B is an equivalent circuit of the power factor corrector during a period T1-T2 in FIG. 2.

FIG. 3C is an equivalent circuit of the power factor corrector during a period T2-T3 in FIG. 2.

FIG. 3D is an equivalent circuit of the power factor corrector during a period T3-T4 in FIG. 2.

FIG. 4 is a graph comparing efficiency of a power factor corrector of a conventional flyback type and a power factor corrector according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

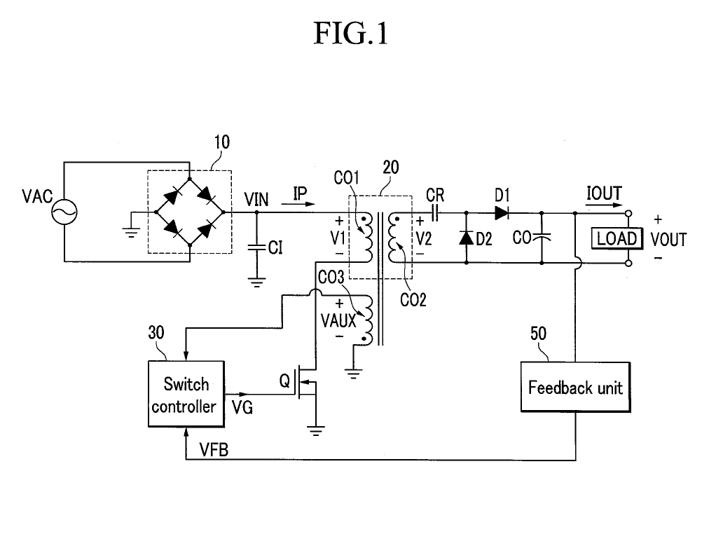

Firstly, an exemplary embodiment of the present invention will be described with reference to FIG. 1.

FIG. 1 is a view showing a power factor corrector according to an exemplary embodiment of the present invention.

As shown in FIG. 1, a converter 1 includes a bridge rectification diode 10 rectifying an input AC voltage VAC, a capacitor CI smoothing the rectified voltage, a transformer 20, a power switch Q, a switch controller 30, a capacitor CR, rectification diodes D1, a diode D2, an output capacitor CO, an auxiliary coil CO3, and a feedback unit 50.

The transformer 20 includes a first coil CO1 positioned at a primary side and a second coil CO2 positioned at a secondary side. The first coil CO1 includes one terminal connected to one terminal of the capacitor CI and transmitted with an input voltage VIN and the other terminal connected to the power switch Q. The second coil CO2 is positioned at the secondary side where an output voltage is generated. The second coil CO2 includes one terminal connected to one terminal of the capacitor CR and the other terminal connected to the anode of the diode D2 of the output filter 40. A predetermined turn ratio (a turn number (ns) of CO2/a turn number (np) of CO1) is determined according to the turn number of the first coil CO1 and the turn number of the second coil CO2, and the voltage of the first coil CO1 and the voltage of the second coil CO2 in the transformer 20 is determined according to the turn ratio nps.

The auxiliary coil CO3 has a predetermined turn ratio for the first coil CO1 of the transformer 20, and the voltage of the first coil CO1 is converted according to the turn ratio and is generated to the auxiliary coil CO3. Hereafter, the voltage of the first coil CO1 is referred to as a primary voltage V1, the voltage of the second coil CO2 is referred to as a secondary voltage V2, and the voltage of the auxiliary coil CO3 is referred to as an auxiliary voltage VAUX.

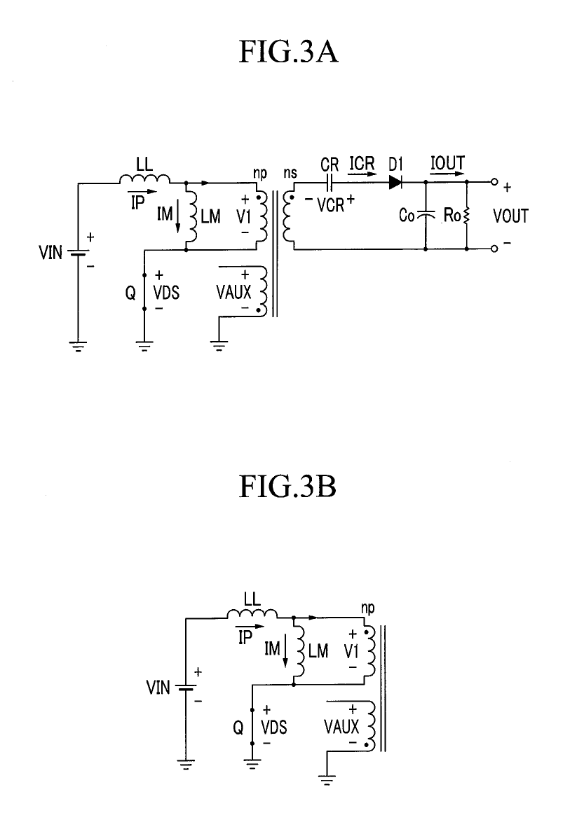

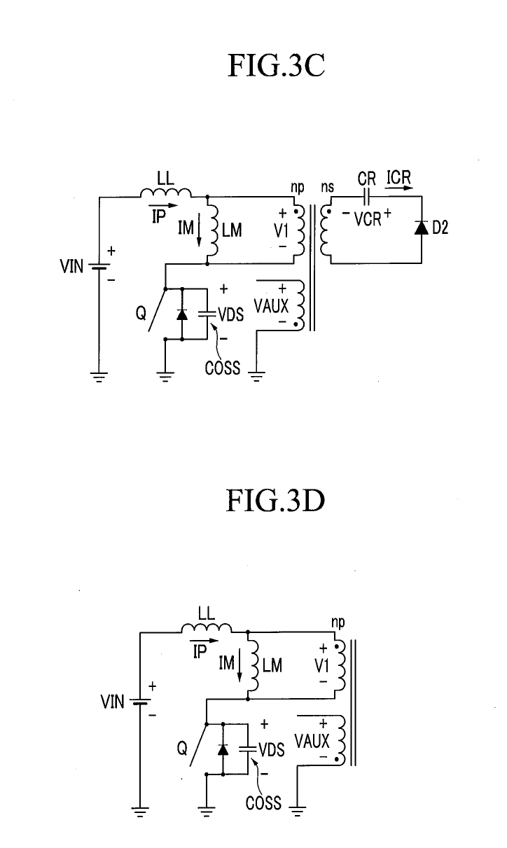

The capacitor CR is connected to the second coil CO2. The capacitor CR includes one terminal connected to one terminal of the second coil CO2 and the other terminal connected to the cathode of the diode D2 and the anode of the rectification diode D1. The capacitor CR is an output filter to remove a ripple of the output voltage VOOT. A resonance is generated between the capacitor CR and the leakage inductance LL (referring to FIG. 3A) of the transformer 20 during the turn-on period of the power switch Q. A resonance is generated between the capacitor CR and a magnetizing inductance LM (referring to FIG. 3C) of the transformer 20 during the turn-off period of the power switch Q. A detailed description thereof will be given with reference to FIGS. 3A-3D.

The diode D2 is connected between the second coil CO2 and the capacitor CR. The diode D3 includes the cathode connected to the capacitor CR and the anode of the rectification diode D1 and the anode connected to the other terminal of the second coil CO2. The diode D2 is turned on during the turn-off period of the power switch Q, and the current ICR generated by the resonance between the capacitor CR and the magnetizing inductance LM flows through the turned-on diode D2.

The rectification diode D1 is connected between the capacitor CR and the output terminal of the power factor corrector 1. The rectification diode D1 includes the anode connected to the cathode of the capacitors CR and diode D2 and the cathode connected to one terminal of the output capacitor CO. The rectification diode D1 is turned on during the turn-on period of the power switch Q, and rectifies the current ICR such that it flows to the load or the output capacitor CO.

The output capacitor CO is charged by the current ICR or supplies the current required for the load.

The feedback unit 50 generates the feedback voltage VFB corresponding to the output voltage to transmit it to the switch controller 30. The feedback voltage is a value that is decreased and increased according to decreasing and increasing of the output voltage.

The switch controller 30 turns off the power switch Q if a lamp signal (not shown) that is increased with a uniform slope during the turn-on period of the power switch Q arrives at the feedback voltage VFB, and turns on the power switch Q after a predetermined delay period from a time that the auxiliary voltage VAUX starts to decrease. The auxiliary voltage VAUX as a voltage flowing to the drain-source voltage VDS of the power switch Q also starts to decrease if the drain-source voltage VDS starts to decrease. The delay period may be determined as a period in which the drain-source voltage VDS starts to decrease and becomes 0. The switch controller 30 generates a gate voltage VG controlling the switching operation of the power switch Q to transmit it to the gate electrode of the power switch Q.

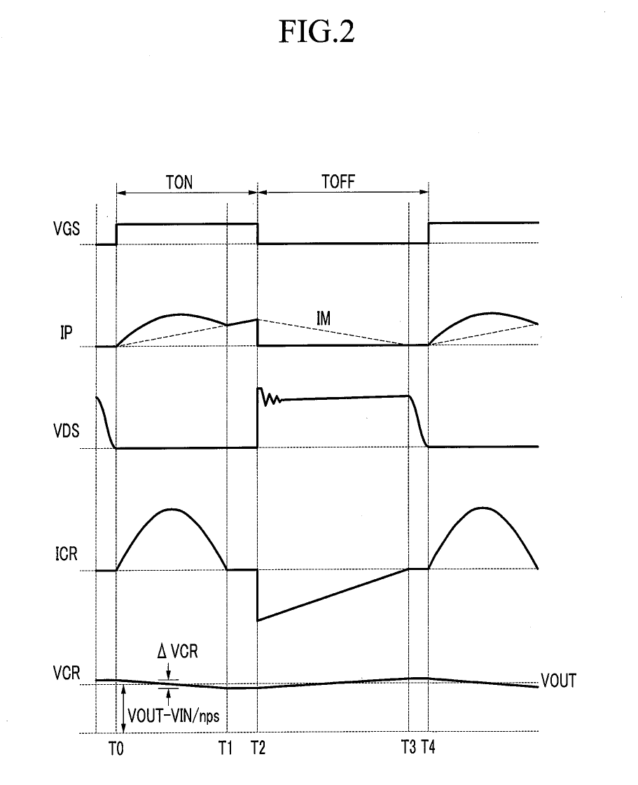

Next, an operation of a power factor corrector according to an exemplary embodiment of the present invention will be described with reference to FIG. 2 and FIGS. 3A-3D.

FIG. 2 is a waveform diagram showing a gate voltage VGS, a primary current IP, a drain-source voltage VDS, a current ICR, and a capacitor voltage VCR during a switching cycle of the power switch Q.

FIGS. 3A-3D are equivalent views dividing and showing the operation of the power factor corrector by time during a period of one switching cycle.

FIG. 3A is an equivalent circuit of the power factor corrector during a period T0-T1 in FIG. 2.

FIG. 3B is an equivalent circuit of the power factor corrector during a period T1-T2 in FIG. 2.

FIG. 3C is an equivalent circuit of the power factor corrector during a period T2-T3 in FIG. 2.

FIG. 3D is an equivalent circuit of the power factor corrector during a period T3-T4 in FIG. 2.

If the gate voltage VGS controlling the power switch Q becomes the high level at the time T0, the power switch Q is turned on such that the drain-source voltage VDS becomes 0. Here, the resonance is generated between the leakage inductance LL and the capacitor CR such that the primary current IP starts to flow. The magnetizing current IM indicated by a dotted line in FIG. 2 is the current flowing in the magnetizing inductance LM. The primary current IP is the sum of the magnetizing current IM and the current flowing in the first coil CO1. The difference between the primary current IP and the magnetizing current IM turns on the rectification diode D1. The current ICR is the current generated when the difference between the primary current IP and the magnetizing current IM is transmitted to the secondary side, and starts to flow from the time T0. The voltage VCR between both terminals of the capacitor CR is increased and decreased according to the current ICR with reference to the voltage of the input voltage divided by the turn ratio is subtracted from the output voltage. If the current ICR is more than 0 (a direction output from the capacitor CR), the capacitor voltage VCR is decreased, and if the current ICR is less than 0 (a direction input to the capacitor CR), the capacitor voltage VCR is increased. The output current IO is determined according to the load.

If the primary current IP and the magnetizing current IM are equal to each other at the time T1, the secondary voltage V2 is less than the sum of the output voltage VOUT and the capacitor voltage VCR such that the rectification diode D2 is blocked and the current ICR does not flow. As shown in FIG. 3B, the current ICR does not flow to the time that the power switch Q is turned off, and the output current 10 does not flow during the period T1-T2. The capacitor voltage VCR is uniformly maintained during this period.

The power switch Q is turned off at the time T2, and the primary current IP is rapidly decreased and the voltage VDS is rapidly increased. As shown in FIG. 3C, the magnetizing current IM is transmitted to the secondary side such that the current ICR is generated and the diode D2 is turned on. Accordingly, the voltage stress of the diode D1 is fixed as the output voltage VO. Also, the capacitor voltage VCR is reflected to the primary side, and the resonance between the magnetizing inductance LM and the capacitor CR is started. The magnetizing current IM is decreased during the period T2-T3 such that the current ICR is also decreased.

If the transformer 20 loses all the magnetism at the time T3, as shown in FIG. 3D, the current no longer flows through the diode D2. Thus, the resonance is generated between the magnetizing inductance LM and the parasitic capacitor COSS of the power switch Q. Accordingly, the drain-source voltage VDS starts to decrease. Here, the auxiliary voltage VAUX is rapidly decreased. The power switch Q is turned on after the delay period T3-T4 from that time. That is, the power switch Q is controlled to be turned on to minimize the switching loss when the drain-source voltage VDS is lowest.

The power factor corrector according to an exemplary embodiment of the present invention uses the capacitor CR as the output filter such that the efficiency of the power factor corrector may be increased compared with the conventional art.

Firstly, as shown in FIGS. 3A-3D, the capacitor voltage VCR is changed according to the current ICR with reference to the voltage VOUT-VIN/nps that is the voltage VIN/nps of which the input voltage VIN is divided by the turn ratio subtracted from the output voltage VOUT. The changing width of the capacitor voltage VCR according to the current ICR is small such that the capacitor voltage VCR is maintained as the voltage VOUT-VIN/nps.

Thus, the voltage of two terminals of the rectification diode D1 of the present invention is the voltage that is less than the voltage of the two terminals of the rectification diode positioned at the secondary side of the conventional power factor corrector by the capacitor voltage VCR.

Accordingly, the rectification diode having the low withstand voltage may be used compared with the conventional art. Therefore, if the rectification diode having the low withstand voltage is used, the forward voltage as the voltage of the two terminals of the rectification diode is decreased such that turned-on loss (conduction loss) is also decreased.

Also, when a MOSFET element is used instead of the rectification diode, the MOSFET element having a low withstand voltage may be used such that the power factor corrector of the present invention may use the MOSFET element having the low on-resistance compared with the conventional art. Accordingly, in the case of using the MOSFET, the turn on loss may be reduced.

Also, when using the conventional inductor as the output filter, the period in which the output voltage is increased to the peak is generated. To remove the peak of the output voltage, the snubber circuit is used and the snubber circuit includes a resistor. Accordingly, during the period in which the snubber circuit is operated, the power loss is generated in the resistor by the peak of the output voltage. However, the power factor corrector according to an exemplary embodiment of the present invention uses the capacitor as the output filter such that the peak of the output voltage is not generated and it is not necessary to use the snubber circuit. Accordingly, the power loss generated in the snubber circuit may be prevented.

Also, the current flowing to the power switch at the time of the turn-off of the power switch is lower than the conventional power factor corrector. In the conventional power factor corrector, the current flowing to the power switch is increased from the turn-on time to the turn-off time. Accordingly, when the power switch is turned off, the current flowing to the power switch is largest. In the power factor corrector according to an exemplary embodiment of the present invention, the current flowing to the power switch Q is decreased before the turn-off time such that the power switch is turned off when the low current flows compared with the conventional art. Accordingly, the turn-off loss of the power switch may be decreased.

As described above, the power factor corrector according to an exemplary embodiment of the present invention largely reduces the power loss compared with the conventional art.

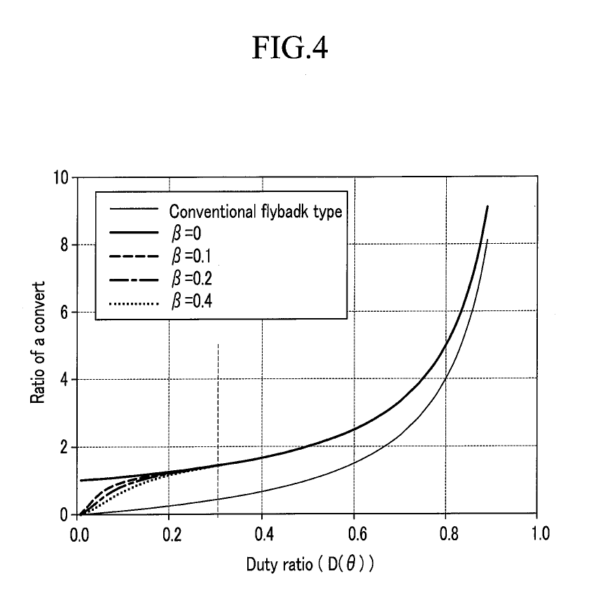

FIG. 4 is a graph comparing efficiency of a power factor corrector of a conventional flyback type and a power factor corrector according to an exemplary embodiment of the present invention.

Equation 1 shows a rate of an input-output conversion of a power factor corrector according to an exemplary embodiment of the present invention.

$$\frac{VOUT}{VIN} = \frac{1}{nps [ ( 1 - D ( θ ) + α ]} \\ Here , α = \frac{T}{RO \times CR} ( \frac{1}{1 - cos ( {w}_{R} {t}_{ON}} - \frac{1}{2} ) . \qquad ( Equation 1 )$$

When T/(RO*CR) is referred to as β, in FIG. 4, the ratio of the input-output conversion VOUT/VIN according to the duty ratio D(θ) for β is shown.

R0 and w_{R} are defined by Equation 2.

$$RO = \frac{VOUT}{IOUT} , {w}_{R} = \frac{nps}{\sqrt{LL \times CR}} \qquad ( Equation 2 )$$

As shown in FIG. 4, the ratio of the input-output conversion is better than the power factor corrector of the conventional flyback type at any duty ratio. β is decreased as the capacity of the capacitor CR is increased, and when β is small, the ratio of the input-output convert is good in the low duty ratio. Accordingly, the ratio of the input-output convert may be realized in any input voltage range by controlling the capacitor CR.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### <Description of Symbols>

converter 1, input AC voltage VAC, bridge rectification diode 10

capacitor CI, transformer 20, power switch Q, switch controller 30

capacitor CR, rectification diode D1, diode D2, output capacitor CO

auxiliary coil CO3, feedback unit 50, first coil CO1, second coil CO2

What is claimed is:

1. A power factor corrector comprising:
a transformer including a first coil of a primary side transmitted with an input voltage and a second coil of a secondary side generating an output voltage;
a power switch connected to the first coil;
a capacitor to remove a ripple of the output voltage; and
a diode connected between the capacitor and the second coil,
wherein a resonance is generated between the capacitor and a leakage inductance of the transformer during a turn-on period of the power switch, and a resonance is generated between the capacitor and the magnetizing inductance of the transformer during the turn-off period of the power switch.

2. The power factor corrector of claim 1, wherein
the resonance starts between the capacitor and the leakage inductance of the transformer in synchronization with the turn-on time.

3. The power factor corrector of claim 1, wherein
the resonance starts between the capacitor and the magnetizing inductance of the transformer, when the transformer loses all magnetism during the turn-off period of the power switch.

4. The power factor corrector of claim 1, further comprising
a rectification diode connected between the capacitor and the output terminal of the power factor corrector.

5. The power factor corrector of claim 4, wherein
the capacitor includes one terminal connected to one terminal of the second coil and the other terminal connected to the anode of the rectification diode,
the anode of the diode is connected to the other terminal of the capacitor, and the cathode of the diode is connected to the other terminal of the second coil.

6. The power factor corrector of claim 1, further comprising:
a feedback unit generating a feedback voltage corresponding to the output voltage; and
a switch controller turning off the power switch when a lamp signal that increases with a predetermined slope during a turn-on period of the power switch arrives at the feedback voltage, and turning on the power switch after a predetermined delay period from a time that a drain-source voltage of the power switch starts to decrease.

7. The power factor corrector of claim 6, further comprising
an auxiliary coil generating an auxiliary voltage that the voltage of the first coil is converted with a predetermined turn ratio,
wherein the controller turns on the power switch after the delay period from the time that the auxiliary voltage starts to decrease.

8. A method for driving a power factor corrector including a transformer including a first coil of a primary side transmitted with an input voltage and a second coil of a secondary side generating an output voltage, a power switch controlling the operation of the transformer, and a capacitor connected to the second coil, comprising:
generating a resonance between the capacitor and a leakage inductance of the transformer during a turn-on period of the power switch; and
generating a resonance between the capacitor and the magnetizing inductance of the transformer during the turn-off period of the power switch.

9. The method of claim 8, wherein
the generating of the resonance between the capacitor and the leakage inductance of the transformer during the turn-on period of the power switch starts from a time that the power switch is turned on.

10. The method of claim 8, wherein
the generating of the resonance between the capacitor and the magnetizing inductance of the transformer during the turn-off period of the power switch starts when the magnetism of the transformer is extinct.

11. The method of claim 8, further comprising:
generating a feedback voltage corresponding to the output voltage;
turning off the power switch when a lamp signal that increases with a predetermined slope during the turn-on period of the power switch arrives at the feedback voltage; and
turning on the power switch after a predetermined delay period from a time that the drain-source voltage of the power switch starts to decrease.
